(19) United States
(12) Patent Application Publication
(10) Pub. No.: US 2023/0263186 A1
(43) Pub. Date: Aug. 24, 2023

(54) EDIBLE SUBSTRATE STICKER SYSTEM

(71) Applicant: Kristina Schlegel, Walnut Creek, CA (US)

(72) Inventor: Kristina Schlegel, Walnut Creek, CA (US)

(21) Appl. No.: 18/166,537

(22) Filed: Feb. 9, 2023

Related U.S. Application Data
(60) Provisional application No. 63/312,524, filed on Feb. 22, 2022.

(51) Int. Cl. A23G 9/48; A23P 20/20; A23P 10/10; A23G 9/50

(52) U.S. Cl. CPC A23G 9/48; A23P 20/20; A23P 10/10; A23G 9/503

(57) ABSTRACT

An edible substrate system may have an edible substrate disposed on a backing substrate and a decorative substrate disposed on the edible substrate. The edible substrate may be cut to define a profile to define edible substrate stickers. Edible substrate stickers may be peelable from the backing substrate without jeopardizing the integrity of the edible sticker or decorative substrate thereon.

### CROSS-REFERENCE TO RELATED APPLICATIONS

This application claims the benefit of U.S. provisional patent application No. 63/312,524 filed on Feb. 22, 2022.

### TECHNICAL FIELD

The embodiments generally relate to the field of decorative sugar or icing in the form of preformed substrates.

### BACKGROUND

Edible paper, including icing sheets, sugar sheets, rice paper, or sugar paper are commonly sold in large sheets. Edible ink may be printed onto edible paper Edible paper is typically limited in shape and arrangement due to the fragility of edible paper, resulting in sugar sheets in simple square, rectangle, or circular shapes. Edible paper commonly has a substrate thickness of 0.16 millimeter or less. The thickness of the substrate makes it difficult to peel from an underlying substrate and prevents users, particularly children, from cutting the sheets into unique and small-sized shapes that can be peeled away from an underlying substrate without tearing the edible paper. Existing edible paper may adhere to frosted or iced surfaces of confections for extended periods of time but will result in deteriorating the image quality of the edible ink thereon.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

An edible substrate system may have an edible substrate disposed on a backing substrate and a decorative substrate disposed on the edible substrate. The decorative layer may depict toy themed subject matter, holiday themed subject material, animals, letters, numbers, words, phrases, or other various subject matter. The edible substrate may be cut or punched to define a profile or silhouette to define edible substrate stickers. Edible substrate stickers may be peelable from the backing substrate and placed on confections, treats, or the like.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates an edible substrate as described herein;

FIG. 2 illustrates a perspective view of an edible substrate as described herein; and

FIG. 3 illustrates a cross-sectional view of an edible substrate as described herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, “edible paper” and variations on that term may include icing sheets, sugar sheets, frosting sheets, rice paper, sugar paper, or the like. Edible paper may include ingredients such as, but not limited to, sugar, tapioca, gum, or starches. Edible paper may be disposed on confectionary treats, baked goods, icing, frosting, fondant, creams, cookies, and various other substances.

In general, the embodiments described herein relate to an edible substrate including an edible paper disposed on a backing substrate. The edible substrate may include a decorative substrate at least partially disposed on the edible substrate. According to some embodiments, the decorative substrate may be a printed edible ink displaying several different images relating to various subject matter such as, but not limited to, toys, animals, birthday themed subject matter, holiday themed subject material, letters, numbers, words, phrases, or other various subject matter. The decorative substrate may be formulated to prevent color or ink into edible paper or substrate.

The edible substrate may be disposed on a backing substrate constructed and arranged to provide support for the edible substrate while also allowing ease of release from the backing substrate such that a user may easily peel the edible paper from the backing substrate.

According to some embodiments, the edible substrate may be approximately 0.32 millimeters thick. According to some embodiments, the edible substrate may be approximately 0.29 millimeters to approximately 0.35 millimeters thick. According to some embodiments, the edible substrate may be approximately 0.27 millimeters to approximately 0.37 millimeters thick. According to some embodiments, the edible substrate may be approximately 0.25 millimeters to approximately 0.39 millimeters thick.

The edible substrate may be die-cut or kiss-cut to form distinct edible substrate shapes and in some cases, may be die cut or kiss cut to reflect the approximate silhouette of portions of a decorative substrate disposed on the edible substrate. As a nonlimiting example, portions of a decorative substrate may depict cartoon animals and the die cut or kiss cut may define a margin of the distinct edible substrate outlining or contouring the image of the cartoon animals. Alternatively, the decorative substrate may include a bleed portion such that the silhouette cut may trim a portion of the decorative substrate off thereby ensuring that the resulting edible sticker has decorative substrate covering the entirety of its upper surface.

The unique application of the disclosed edible substrate thickness and die-cut or kiss cut method provides an edible substrate that is thick enough so that small, uniquely shaped pieces can be easily peeled from the backing substrate by a user, and particularly children. The edible substrate is also thin enough to still be flexible enough to peel from the backing substrate. The disclosed edible substrate maintains acceptable properties of taste and texture and mouth feel when eaten. The thickness also allows for the edible substrate to adhere to frosted or iced surfaces of confections for extended periods of time without deteriorating the image quality of the decorative substrate thereon.

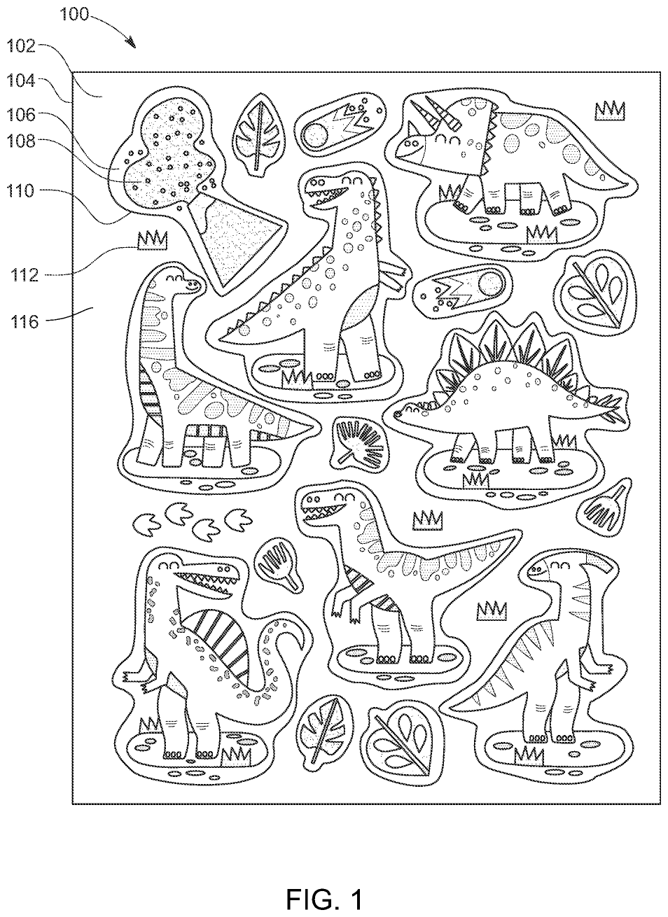

FIG. 1 illustrates an edible substrate system 100 having an edible substrate 102 disposed on a backing substrate 104. A decorative substrate 108 may be disposed on the edible substrate 102. The edible substrate 102 may be cut to define a profile 110, such as by die cut methods, to define edible substrate stickers 106. Edible stickers 106 may be peelable from the backing substrate 104 without jeopardizing the integrity of the edible sticker 106, a remainder portion 116, or decorative substrate 108 thereon. Additionally, profile 110 may define a separation between the edible sticker 106 and the edible substrate 102 such that the edible stickers 106 may be peelable from the backing substrate 104 without jeopardizing the integrity of the edible sticker 106, remainder portion 116, or decorative substrate 108 thereon. Additional decorative substrates 112 may also be disposed on the edible substrate 102 but which may not be cut from the edible substrate 102.

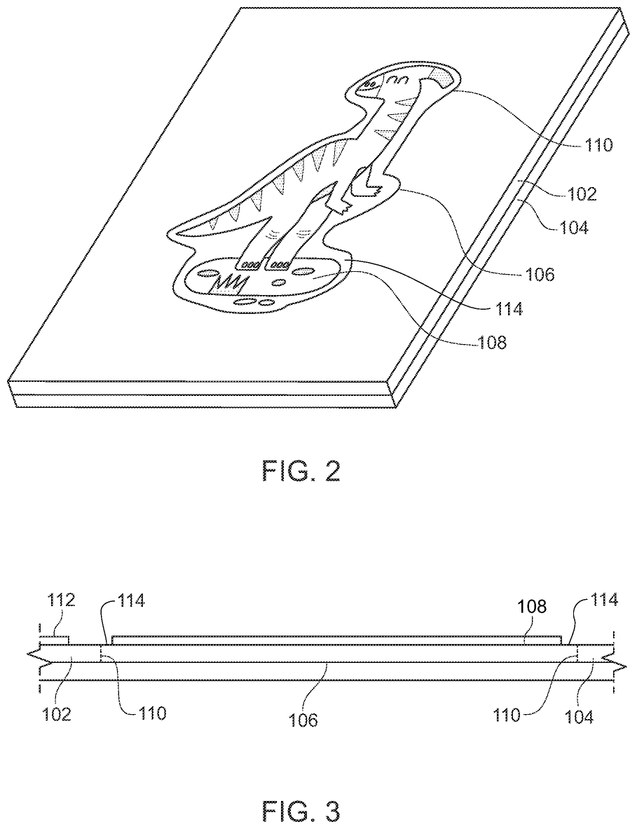

FIG. 2 illustrates a perspective view of an edible substrate 102 disposed on a backing substrate 104. A decorative substrate 108 may be disposed on the edible substrate 102. The edible substrate 102 may be cut or stamped to define a profile 110 to define edible substrate stickers 106. Profile 110 may outline, contour, or silhouette the decorative substrate 108 at a distance and include a contouring margin 114 of the edible substrate 102 without the decorative substrate 108 thereon.

FIG. 3 illustrates a cross-sectional view of an edible substrate 102 disposed on a backing substrate 104. A decorative substrate 108 may be disposed on the edible substrate 102. The edible substrate 102 may be cut or stamped to define a profile 110 to define edible substrate stickers 106. According to some embodiments, the profile 110 may separate a remainder portion of the edible substrate 102 from the edible substrate sticker 106. According to some embodiments, the profile 110 may also be cut through a portion of the backing substrate 104 such that the edible substrate sticker 106 and a portion of the backing substrate 104 may be removed. Additional decorative substrates 112 may also be disposed on the edible substrate 102 but which may not be cut from the edible substrate 102. Profile 110 may silhouette the decorative substrate 108 at a distance and include a contouring margin 114 of the edible substrate 102 without the decorative substrate 108 thereon.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, an edible sticker product may include a backing substrate; an edible substrate removably disposed on the backing substrate, the edible substrate including at least one edible sticker and an edible remainder; and at least one decorative substrate disposed on the at least one edible sticker.

Variation 2 may include edible sticker product as in variation 1, wherein the edible substrate is approximately 0.32 millimeters thick.

Variation 3 may include edible sticker product as in variation 1 or 2, wherein the edible substrate is approximately 0.29 millimeters to approximately 0.35 millimeters thick.

Variation 4 may include edible sticker product as in any of variations 1 through 3, wherein the edible substrate is approximately 0.27 millimeters to approximately 0.37 millimeters thick.

Variation 5 may include edible sticker product as in any of variations 1 through 4, wherein the edible substrate is approximately 0.25 millimeters to approximately 0.39 millimeters thick.

Variation 6 may include edible sticker product as in any of variations 1 through 5, wherein the at least one edible sticker and the edible remainder are separate from one another via a kiss cut.

Variation 7 may include edible sticker product as in any of variations 1 through 6, wherein the backing substrate is not cut.

Variation 8 may include edible sticker product as in any of variations 1 through 7, wherein the kiss cut defines at least one cut profile that approximately silhouettes the at least one decorative substrate.

Variation 9 may include edible sticker product as in any of variations 1 through 8, wherein the at least one edible sticker and the edible remainder are separate from one another via a die cut.

Variation 10 may include edible sticker product as in any of variations 1 through 9, wherein the die cut defines at least one cut profile that approximately silhouettes the at least one decorative substrate.

Variation 11 may include edible sticker product as in any of variations 1 through 10, wherein the at least one edible sticker includes a contouring margin without the at least one decorative substrate disposed thereon.

Variation 12 may include edible sticker product as in any of variations 1 through 11, wherein the at least one decorative substrate disposed on the at least one edible sticker does not bleed color into the plurality of edible stickers.

Variation 13 may include edible sticker product as in any of variations 1 through 12, wherein the edible substrate includes at least one of icing sheet, sugar sheet, frosting sheet, rice paper, or sugar paper.

Variation 14 may include an edible sticker product, wherein the product is prepared by providing a backing substrate; disposing an edible substrate on the backing substrate, the edible substrate comprising at least one of an icing sheet, sugar sheet, frosting sheet, rice paper, or sugar paper, wherein the edible substrate further comprises at least one edible remainder kiss-cut from the edible substrate; disposing a plurality of edible stickers on the edible substrate; and disposing a plurality of decorative substrates on the plurality of edible stickers.

Variation 15 may include an edible substrate sticker product as in variation 14, wherein the edible substrate is approximately 0.32 millimeters thick.

Variation 16 may include an edible substrate sticker product as in variation 14 or 15, wherein the edible substrate is approximately 0.29 millimeters to approximately 0.35 millimeters thick.

Variation 17 may include an edible substrate sticker product as in any of variations 14 or 16, wherein the edible substrate is approximately 0.27 millimeters to approximately 0.37 millimeters thick.

Variation 18 may include an edible substrate sticker product as in any of variations 14 or 17, wherein the edible substrate is approximately 0.25 millimeters to approximately 0.39 millimeters thick.

Variation 19 may include an edible substrate sticker product as in any of variations 14 or 18, wherein the plurality of decorative substrates disposed on the plurality of edible stickers do not bleed color into the plurality of edible stickers.

Variation 20 may include an edible sticker product including backing substrate; an edible substrate approximately 0.29 millimeters to approximately 0.35 millimeters thick including at least one of icing sheet, sugar sheet, frosting sheet, rice paper, or sugar paper removably disposed on the backing substrate, wherein the edible substrate includes a plurality of edible stickers and at least one edible remainder kiss-cut from the edible substrate; and a plurality of decorative substrates disposed on the plurality of edible stickers, wherein each of the plurality of decorative substrates are dimensioned to define a contouring margin on the plurality of edible stickers without the at least one decorative substrate disposed thereon.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

I/We claim:

1. An edible sticker product, comprising:
a backing substrate;
an edible substrate removably disposed on the backing substrate, the edible substrate comprising at least one edible sticker and an edible remainder; and
at least one decorative substrate disposed on the at least one edible sticker.

2. An edible sticker product as in claim 1, wherein the edible substrate is approximately 0.32 millimeters thick.

3. An edible sticker product as in claim 1, wherein the edible substrate is approximately 0.29 millimeters to approximately 0.35 millimeters thick.

4. An edible sticker product as in claim 1, wherein the edible substrate is approximately 0.27 millimeters to approximately 0.37 millimeters thick.

5. An edible sticker product as in claim 1, wherein the edible substrate is approximately 0.25 millimeters to approximately 0.39 millimeters thick.

6. An edible sticker product as in claim 1, wherein the at least one edible sticker and the edible remainder are separate from one another via a kiss cut.

7. An edible sticker product as in claim 6, wherein the backing substrate is not cut.

8. An edible sticker product as in claim 6, wherein the kiss cut defines at least one cut profile that approximately silhouettes the at least one decorative substrate.

9. An edible sticker product as in claim 1, wherein the at least one edible sticker and the edible remainder are separate from one another via a die cut.

10. An edible sticker product as in claim 9, wherein the die cut defines at least one cut profile that approximately silhouettes the at least one decorative substrate.

11. An edible sticker product as in claim 1, wherein the at least one edible sticker comprises a contouring margin without the at least one decorative substrate disposed thereon.

12. An edible substrate sticker product as in claim 1, wherein the at least one decorative substrate disposed on the at least one edible sticker does not bleed color into the at least one edible sticker.

13. An edible substrate sticker product as in claim 1, wherein the edible substrate comprises at least one of icing sheet, sugar sheet, frosting sheet, rice paper, or sugar paper.

14. An edible sticker product, wherein the product is prepared by:
providing a backing substrate;
disposing an edible substrate on the backing substrate, the edible substrate comprising at least one of an icing sheet, sugar sheet, frosting sheet, rice paper, or sugar paper, wherein the edible substrate further comprises at least one edible remainder kiss-cut from the edible substrate;
disposing a plurality of edible stickers on the edible substrate; and
disposing a plurality of decorative substrates on the plurality of edible stickers.

15. An edible substrate sticker product as in claim 14, wherein the edible substrate is approximately 0.32 millimeters thick.

16. An edible substrate sticker product as in claim 14, wherein the edible substrate is approximately 0.29 millimeters to approximately 0.35 millimeters thick.

17. An edible substrate sticker product as in claim 14, wherein the edible substrate is approximately 0.27 millimeters to approximately 0.37 millimeters thick.

18. An edible substrate sticker product as in claim 14, wherein the edible substrate is approximately 0.25 millimeters to approximately 0.39 millimeters thick.

19. An edible substrate sticker product as in claim 14, wherein the plurality of decorative substrates disposed on the plurality of edible stickers do not bleed color into the plurality of edible stickers.

20. An edible sticker product, comprising:
a backing substrate;
an edible substrate approximately 0.29 millimeters to approximately 0.35 millimeters thick comprising at least one of icing sheet, sugar sheet, frosting sheet, rice paper, or sugar paper removably disposed on the backing substrate, wherein the edible substrate comprises a plurality of edible stickers and at least one edible remainder kiss-cut from the edible substrate; and
a plurality of decorative substrates disposed on the plurality of edible stickers, wherein each of the plurality of decorative substrates are dimensioned to define a contouring margin on the plurality of edible stickers without the plurality of decorative substrates disposed thereon.
